(19) United States
(12) Patent Application Publication
(10) Pub. No.: US 2024/0102652 A1
(43) Pub. Date: Mar. 28, 2024

(54) LINER FOR GROOVE OF GAS TURBINE ENGINE AND METHOD OF MANUFACTURING THEREOF

(71) Applicant: ROLLS-ROYCE plc, London (GB)

(72) Inventor: Ewan F THOMPSON, Derby (GB)

(73) Assignee: ROLLS-ROYCE plc, London (GB)

(21) Appl. No.: 18/215,271

(22) Filed: Jun. 28, 2023

(30) Foreign Application Priority Data
Jul. 18, 2022 (GB) 2210496.2

(51) Int. Cl. F23R 3/00; B21D 53/84; F23R 3/42

(52) U.S. Cl. CPC F23R 3/002; B21D 53/84; F23R 3/42

(57) ABSTRACT

A liner for use with a gas turbine engine includes a first liner portion including a first upstream surface and a first downstream surface. The liner further includes a second liner portion spaced apart from the first liner portion. The second liner portion includes a second upstream surface and a second downstream surface. The second upstream surface faces the first downstream surface. Each of the first liner portion and the second liner portion at least circumferentially and radially extends with respect to a central axis. Each of the first liner portion and the second liner portion includes a substrate made of a metallic material and a wear resistant coating disposed on at least a portion of the substrate. The wear resistant coating is made of a polymeric material. The wear resistant coating at least forms the first downstream surface and the second upstream surface.

### FIELD OF THE DISCLOSURE

The present disclosure generally relates to a gas turbine engine. More particularly, the present disclosure relates to a liner for use with a groove of a gas turbine engine and a method of manufacturing thereof.

### BACKGROUND

Gas turbine engines for aircrafts typically include a compressor and fan casing that interfaces with nacelle components, such as thrust reversers that are used for ground deceleration. For example, the thrust reverser may be located within an outer cowling constructed as pivoting clamshell structures. Such nacelle components may be detachably coupled to the casing and may also function as doors to allow access to inside of the gas turbine engine for installation and maintenance purposes.

In one known arrangement, the interface between the casing and the clamshell structure typically includes a securing means (e.g., a V-shaped blade) provided on the clamshell structure that engages with a groove (e.g., a V-shaped groove) disposed on the casing when the thrust reversers are shut. Such an arrangement may allow structural loads to be transmitted across the interface between the casing and the clamshell structure and may also serve as a sealing for a flow of air. Since the securing means is not completely fixed within the groove, relative motion may occur between the blade and the groove, thereby causing fretting of the groove as well as the blade. Fretting may cause damage that must be repaired, or may result in the casing or the blade being scrapped. Such a wear mechanism exists with commonly used materials for the interface, such as aluminium and titanium.

It may be desirable to increase a service life of the blade and the groove while retaining the conventional groove and blade geometry. Conventional design solutions include grooves that are lined with wear resistant metals or composite materials to prevent excessive fretting at the interface. Some liners are typically formed as a one-piece ring. Metallic liners may be subjected to wear in a similar manner as the conventional metallic grooves and blades. Use of composite materials may not be a cost-effective solution. Therefore, a more robust wear protection solution is desired that increases a service life of the interface and may also offer greater durability and cost savings.

### SUMMARY

According to a first aspect, there is provided a liner for use with a gas turbine engine having a groove. The liner includes at least one first liner portion including a first upstream surface and a first downstream surface opposite to the first upstream surface. The first upstream surface is configured to at least partially engage with a first groove surface of the groove. The liner further includes at least one second liner portion spaced apart from the at least one first liner portion. The second liner portion includes a second upstream surface and a second downstream surface opposite to the second upstream surface. The second downstream surface is configured to at least partially engage with a second groove surface of the groove and the second upstream surface faces the first downstream surface. Each of the at least one first liner portion and the at least one second liner portion at least circumferentially and radially extends with respect to a central axis. Each of the at least one first liner portion and the at least one second liner portion includes a substrate made of a metallic material and a wear resistant coating disposed on at least a portion of the substrate. The wear resistant coating is made of a polymeric material. The wear resistant coating at least forms the first downstream surface of the at least one first liner portion and the second upstream surface of the at least one second liner portion.

The liner may cover internal surfaces of the groove, i.e., the first groove surface and the second groove surface of the groove. The groove may engage with a blade of a mating component. Thus, the liner may protect the first groove surface and the second groove surface from wear against contact stresses arising due to the engagement between the groove and the blade. Specifically, the wear resistant coating of each of the at least one first liner portion and the at least one second liner portion may prevent direct contact between the blade and the groove, thereby protecting the first groove surface and the second groove surface from fretting. Therefore, the liner of the present disclosure may increase an operational life of the groove and may mitigate the need to refurbish the groove during a service life of the gas turbine engine. By eliminating wear, the groove may also be made from relatively low-cost softer materials (e.g., aluminium).

Moreover, the liner of the present disclosure may provide a low-cost solution to prevent wear and tear of the first groove surface and the second groove surface. Presence of the wear resistant coating on the substrate may allow low-cost materials to be chosen for the substrate that are compatible with a material of the groove. Thus, the liner of the present disclosure may eliminate the need to use relatively costlier materials, such as composites, hard and high strength steels. Further, the liner of the present disclosure may ease manufacturing since the liner includes the first liner portion separate from the second liner portion. This may also facilitate in replacement of the at least one first liner portion and the at least one second liner portion upon wear.

Additionally, the liner of the present disclosure may allow a thin metal shim to be chosen as the substrate. The thin metal shim may then be shaped to obtain the liner. Deposition of the wear resistant coating on the substrate of the first liner portion and the second liner portion may offer a low-cost method to produce the liner.

In some embodiments, the at least one first liner portion has a circumferential extent of 360 degrees around the central axis. In some embodiments, the at least one second liner portion has a circumferential extent of 360 degrees around the central axis. Thus, the at least one first liner portion and the at least one first liner portion may mitigate wear of the groove all around the central axis.

In some embodiments, at least one of the at least one first liner portion and the at least one second liner portion has a hollow frustoconical shape around the central axis. The hollow frustoconical shape of the at least one first liner portion or the at least one second liner portion may allow improved engagement with a corresponding shape of the first groove surface or the second groove surface.

In some embodiments, the at least one first liner portion includes a plurality of first liner portions disposed circumferentially around the central axis. In some embodiments, the at least one second liner portion includes a plurality of second liner portions disposed circumferentially around the central axis. The plurality of first liner portions and the plurality of second liner portions may facilitate installation of the liner on the groove. Further, individual first and second liner portions may be conveniently replaced upon wear, thereby reducing a cost of maintenance.

In some embodiments, the plurality of first liner portions is disposed circumferentially adjacent to each other around the central axis. In some embodiments, the plurality of second liner portions is disposed circumferentially adjacent to each other around the central axis. Thus, the plurality of first and second liner portions may fully cover the first and second groove surfaces of the groove, respectively, while also reducing a cost of maintenance.

In some embodiments, the plurality of first liner portions is angularly spaced apart from each other with respect to the central axis. In some embodiments, the plurality of second liner portions is angularly spaced apart from each other with respect to the central axis. In some cases, the blade may not extend 360 degrees around the central axis. In such cases, the plurality of first liner portions and the plurality of second liner portions may be utilized at locations corresponding to the location of the blade, thereby allowing reduction in a material required to protect the groove.

In some embodiments, each first liner portion from the plurality of first liner portions forms a hollow frustoconical segment around the central axis. Thus, the hollow frustoconical segment may conform to a corresponding shape of the first groove surface.

In some embodiments, each second liner portion from the plurality of second liner portions forms a hollow frustoconical segment around the central axis. Thus, the hollow frustoconical segment may conform to a corresponding shape of the second groove surface.

In some embodiments, the liner further includes a first radially outer lip extending from the at least one first liner and configured to engage with a first radially outer surface of the groove. In some embodiments, the liner further includes a second radially outer lip extending from the at least one second liner portion and configured to engage with a second radially outer surface of the groove. The first radially outer lip and the second radially outer lip may allow self-fixturing of the liner on the groove. Thus, the first radially outer lip and the second radially outer lip may facilitate installation of the liner on the groove. Further, the first radially outer lip and the second radially outer lip may prevent damage to the liner when the blade engages with the groove since the first radially outer lip and the second radially outer lip may prevent peeling of outer edges of the liner.

In some embodiments, the liner further includes at least one bottom liner portion coupling the at least one first liner portion to the at least one second liner portion. In some embodiments, the at least one bottom liner portion is disposed adjacent to a bottom groove surface of the groove. The at least one bottom liner portion may facilitate installation of the liner on the groove. In some cases, a single bottom liner portion connecting the first liner portion and the second liner portion may be pushed inside the groove with the single bottom liner portion ensuring alignment between the first and second liner portions.

In some embodiments, the at least one bottom liner portion includes a plurality of bottom liner portions spaced apart from each other. In some embodiments, each bottom liner portion from the plurality of bottom liner portions couples the at least one first liner portion to the at least one second liner portion. In some embodiments, each bottom liner portion is disposed adjacent to the bottom groove surface of the groove. The plurality of bottom liner portions may facilitate installation of the liner on the groove while keeping a cost of producing the liner low, e.g., through material savings.

In some embodiments, the at least one first liner portion further includes a first inner circumferential edge proximal to the central axis and a first outer circumferential edge opposing the first inner circumferential edge. In some embodiments, the at least one second liner portion further includes a second inner circumferential edge proximal to the central axis and a second outer circumferential edge opposing the second inner circumferential edge. In some embodiments, each of the plurality of bottom liner portions extends from the first inner circumferential edge to the second inner circumferential edge. Thus, each of the plurality of bottom liner portions couples the at least one first liner portion with the at least one second liner portion.

In some embodiments, the at least one first liner portion is inclined to the at least one second liner portion. Thus, the at least one first liner portion and the at least one second liner portion may be able to protect the surface of the groove where the first groove surface is inclined to the second groove surface, e.g., a V-shaped groove.

In some embodiments, the metallic material includes titanium, steel, aluminium, a nickel-based alloy, a copper-based alloy, or combinations thereof. The metallic material may typically include easily formable metal alloys, thereby allowing cold forming methods to be chosen for producing the liner. Further, the metallic material may be corrosion resistant.

In some embodiments, the polymeric material includes polyimide, polyurethane, polytetrafluoroethylene (PTFE), polyether ether ketone (PEEK), ethylene chlorotrifluoroethylene (ECTFE), ethylene tetrafluoroethylene (ETFE), polyvinylidene fluoride (PVDF), or combinations thereof. The polymeric material may be highly wear resistant, durable, resistant to engine environment (e.g., exposure to corrosive fluids, high temperature, etc.), and compatible with a material of the substrate.

According to a second aspect, there is provided a gas turbine engine including a central axis. The gas turbine engine further includes a casing coaxial with and extending around the central axis. The casing includes a groove circumferentially extending around the central axis. The groove includes a first groove surface and a second groove surface axially spaced apart from the first groove surface relative to the central axis. The gas turbine engine further includes a cowl disposed axially spaced apart from the casing and circumferentially extending around the central axis. The cowl is rotatable relative to the casing and configured to detachably engage with the casing. The cowl includes a radially inner surface proximal to the central axis. The cowl further includes a radially outer surface opposite to the radially inner surface. The cowl further includes a blade extending radially inwards from the radially inner surface towards the central axis. The blade is configured to be at least partially received within the groove of the casing. The gas turbine engine further includes the liner of the first aspect at least partially received within the groove. The at least one first liner portion of the liner at least partially extends along the first groove surface around the central axis. The at least one second liner portion of the liner at least partially extends along the second groove surface around the central axis. The first upstream surface of the at least one first liner portion at least partially engages with the first groove surface of the groove and the first downstream surface of the at least one first liner portion at least partially engages the blade. The second downstream surface of the at least one second liner portion at least partially engages with the second groove surface of the groove and the second upstream surface of the at least one second liner portion at least partially engages the blade.

In some embodiments, the gas turbine engine further includes a first adhesive layer disposed between the first upstream surface and the first groove surface. In some embodiments, the first adhesive layer is configured to adhesively bond the at least one first liner portion to the groove. In some embodiments, the gas turbine engine further includes a second adhesive layer disposed between the second downstream surface and the second groove surface. In some embodiments, the second adhesive layer is configured to adhesively bond the at least one second liner portion to the groove. The first adhesive layer and the second adhesive layer may provide a low-cost solution to attach the first liner portion and the second liner portion to the first groove surface and the second groove surface, respectively. Further, the first adhesive layer and the second adhesive layer may facilitate installation of the liner on the groove.

According to a third aspect, there is provided a method of manufacturing the liner of the first aspect. The method includes providing a sheet metal blank made of the metallic material. The method further includes cutting a first sheet from the sheet metal blank. The method further includes cutting a second sheet from the sheet metal blank. The method further includes bending the first sheet to obtain a first bent portion. The first bent portion includes a first major surface and an opposing second major surface. The method further includes bending the second sheet to obtain a second bent portion. The second bent portion includes a first major surface and an opposing second major surface. The method further includes at least partially coating the first major surface of the first bent portion with the wear resistant coating in order to obtain the at least one first liner portion. The method further includes at least partially coating the second major surface of the second bent portion with the wear resistant coating in order to obtain the at least one second liner portion.

The method may allow bending of the first sheet and the second sheet to obtain the first bent portion and the second bent portion, respectively, before at least partially coating the first major surface of the first bent portion and the second major surface of the second bent portion with the wear resistant coating. This may allow preservation of the wear resistant coating before shaping operations. Such a method may be suitable for the first liner portion and the second liner portion having specific geometries.

According to a fourth aspect, there is provided a method of manufacturing the liner of the first aspect. The method includes providing a sheet metal blank made of the metallic material. The sheet metal blank includes a first major surface and an opposing second major surface. The method further includes at least partially coating the first major surface of the sheet metal blank with the wear resistant coating. The method further includes cutting a first sheet from the sheet metal blank. The method further includes cutting a second sheet from the sheet metal blank. The method further includes bending the first sheet to obtain the at least one first liner portion. The method further includes bending the second sheet to obtain the at least one second liner portion.

Coating the sheet metal blank when flat and then shaping the first sheet and the second sheet to form the first liner portion and the second liner portion, respectively, may offer a low-cost production method. The first sheet and the second sheet may be cut from the coated sheet metal blank through well-known methods, such as shearing, stamping, laser cutting, etc.

### BRIEF DESCRIPTION OF THE DRAWINGS

Embodiments will now be described by way of example only, with reference to the Figures, in which:

FIG. 1 is a schematic sectional side view of a gas turbine engine, according to an embodiment of the present disclosure;

FIG. 2 is a schematic perspective view of the gas turbine engine, according to an embodiment of the present disclosure;

FIG. 3 is a schematic sectional view of a portion of a casing of the gas turbine engine including a groove and a liner, according to an embodiment of the present disclosure;

FIG. 4 is a schematic perspective view of the liner, according to an embodiment of the present disclosure;

FIG. 5 is a schematic perspective view of the liner, according to another embodiment of the present disclosure;

FIG. 6 is a schematic perspective view of the liner, according to yet another embodiment of the present disclosure;

FIG. 7 is a schematic perspective view of the liner of FIG. 6, according to another embodiment of the present disclosure;

FIG. 8 is a schematic sectional view of the portion of the casing including the groove and the liner, according to another embodiment of the present disclosure;

FIG. 9 is a schematic perspective view of the liner of FIG. 8, according to another embodiment of the present disclosure;

FIG. 10 is a flowchart illustrating a method of manufacturing the liner, according to an embodiment of the present disclosure;

FIG. 11A is a schematic perspective view of a sheet metal blank, according to an embodiment of the present disclosure;

FIG. 11B is a schematic perspective view of the sheet metal blank and a first sheet, according to an embodiment of the present disclosure;

FIG. 11C is a schematic perspective view of the sheet metal blank and a second sheet, according to an embodiment of the present disclosure;

FIG. 11D is a schematic side view of an apparatus for bending the first sheet, according to an embodiment of the present disclosure;

FIG. 11E is a schematic side view of the apparatus for bending the second sheet, according to an embodiment of the present disclosure;

FIG. 11F is a schematic perspective view of a portion of a first bent portion, according to an embodiment of the present disclosure;

FIG. 11G is a schematic perspective view of a portion of a second bent portion, according to an embodiment of the present disclosure;

FIG. 12 is a flowchart illustrating a method of manufacturing the liner, according to another embodiment of the present disclosure;

FIG. 13A is a schematic perspective view of a sheet metal blank, according to an embodiment of the present disclosure;

FIG. 13B is a schematic perspective view of the sheet metal blank where a first major surface of the sheet metal blank is at least partially coated, according to an embodiment of the present disclosure;

FIG. 13C is a schematic perspective view of the sheet metal blank and a first sheet, according to an embodiment of the present disclosure;

FIG. 13D is a schematic perspective view of the sheet metal blank and a second sheet, according to an embodiment of the present disclosure;

FIG. 13E is a schematic side view of an apparatus for bending the first sheet, according to an embodiment of the present disclosure; and

FIG. 13F is a schematic side view of the apparatus for bending the second sheet, according to an embodiment of the present disclosure.

### DETAILED DESCRIPTION

Aspects and embodiments of the present disclosure will now be discussed with reference to the accompanying Figures. Further aspects and embodiments will be apparent to those skilled in the art.

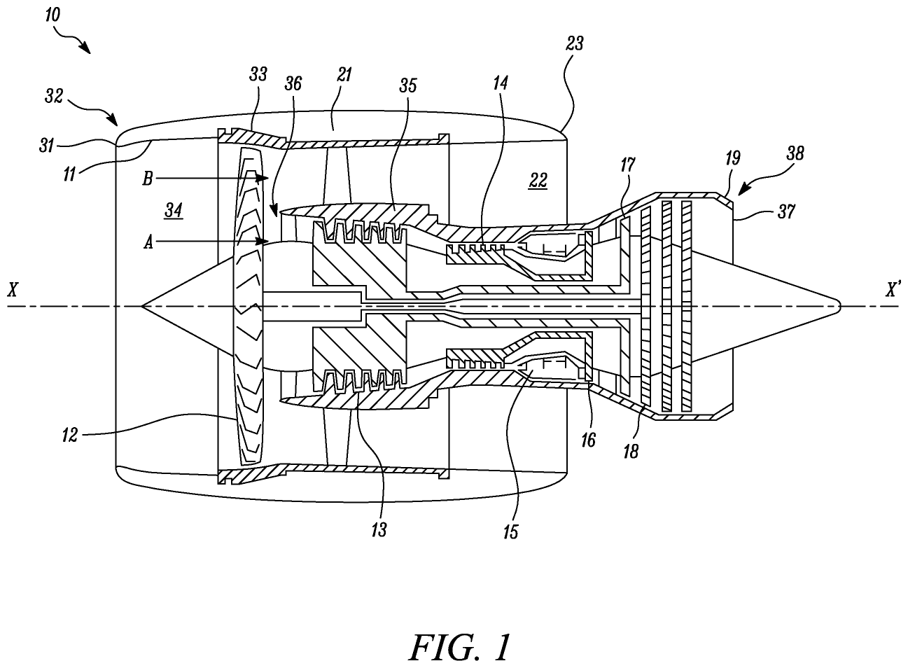

FIG. 1 shows a ducted gas turbine engine 10 having a central axis X-X′. The gas turbine engine 10 includes, in axial flow series, an air intake 11, a propulsive fan 12, an intermediate pressure compressor 13, a high pressure compressor 14, combustion equipment 15, a high pressure turbine 16, an intermediate pressure turbine 17, a low pressure turbine 18 and a core engine exhaust nozzle 19. A nacelle 21 generally surrounds the gas turbine engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high pressure compressor 14 is directed into the combustion equipment 15 where it is mixed with fuel and the mixture is combusted. The resultant hot combustion products then expand through, and thereby, drive the high, intermediate and low pressure turbines 16, 17, 18 before being exhausted through the core engine exhaust nozzle 19 to provide additional propulsive thrust. The high, intermediate and low pressure turbines 16, 17, 18 respectively drive the high and intermediate pressure compressors 14, 13 and the fan 12 by suitable interconnecting shafts.

In some embodiments, the gas turbine engine 10 is used in an aircraft. In some embodiments, the gas turbine engine 10 is an ultra-high bypass ratio engine (UHBPR).

The nacelle 21 further includes an intake lip 31 disposed at an upstream end 32 of the nacelle 21, a fan casing 33 downstream of the intake lip 31, a diffuser 34 disposed between the upstream end 32 and the fan casing 33, and an engine casing 35 downstream of the intake lip 31. The fan 12 is received within the fan casing 33. A core engine 36 of the gas turbine engine 10 including the intermediate pressure compressor 13, the high pressure compressor 14, the combustion equipment 15, the high pressure turbine 16, the intermediate pressure turbine 17, the low pressure turbine 18 and the core engine exhaust nozzle 19 is at least partially received within the nacelle 21. Specifically, the core engine 36 is received within the engine casing 35. The nacelle 21 further includes an exhaust 37 disposed at a downstream end 38 of the nacelle 21. The exhaust 37 may be part of the engine casing 35. The exhaust 37 may at least partly define the core engine exhaust nozzle 19.

The nacelle 21 for the gas turbine engine 10 may be typically designed by manipulating a plurality of design variables. The selection of the design variables may be dependent on a cruise Mach speed of an aircraft the nacelle 21 is attached to, as well as considerations for integration of engine ancillaries, such as a thrust reversal unit (TRU). Optimisation of these variables may be required to minimise the cruise drag incurred due to size and design of the nacelle 21.

The geometry of the gas turbine engine 10, and components thereof, is defined by a conventional axis system, comprising an axial direction (which is aligned with the central axis X-X′), a radial direction (in the bottom-to-top direction in FIG. 1), and a circumferential direction (perpendicular to the page in the FIG. 1 view). The axial, radial and circumferential directions are mutually perpendicular.

In addition, the present invention is equally applicable to aero gas turbine engines, marine gas turbine engines and land-based gas turbine engines.

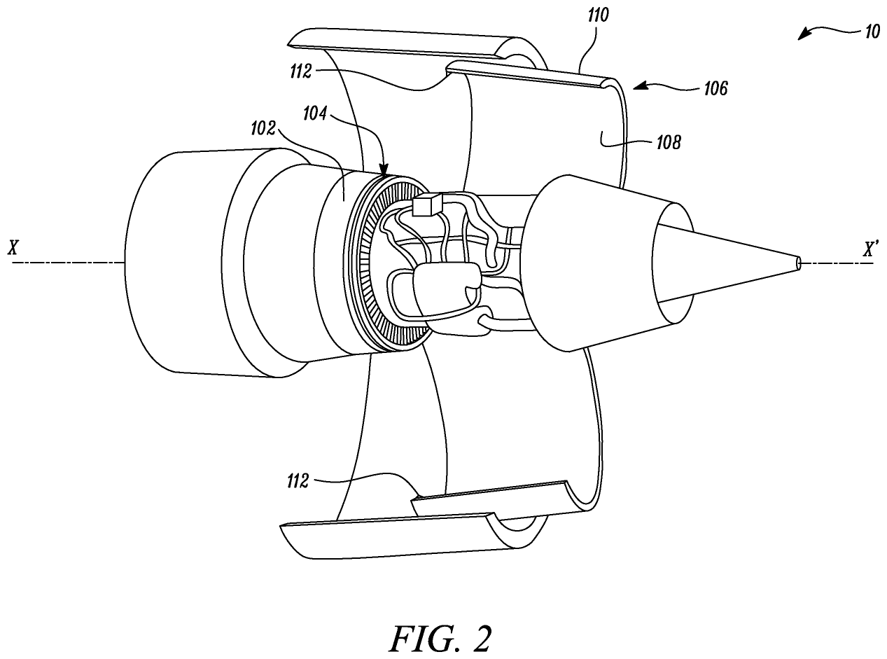

FIG. 2 is a schematic perspective view of the gas turbine engine 10. The gas turbine engine 10 further includes a casing 102 coaxial with and extending around the central axis X-X′. In some embodiments, the casing 102 may be a portion of the nacelle 21 (shown in FIG. 1). In some embodiments, the casing 102 includes a groove 104 circumferentially extending around to the central axis X-X′.

In some embodiments, the groove 104 has a circumferential extent of about 360 degrees around the central axis X-X′. In some embodiments, the groove 104 may extend at least partially around the central axis X-X′. In some embodiments, the groove 104 may include a plurality of grooves 104 circumferentially extending around to the central axis X-X′. In some embodiments, the plurality of grooves 104 may be arranged equiangularly around the central axis X-X′.

The gas turbine engine 10 further includes a cowl 106 disposed axially spaced apart from the casing 102 and circumferentially extending around the central axis X-X′. In some embodiments, the cowl 106 may be a portion of the nacelle 21 (shown in FIG. 1). In some embodiments, the cowl 106 is rotatable relative to the casing 102 and configured to detachably engage with the casing 102. In some embodiments, the cowl 106 includes a radially inner surface 108 proximal to the central axis X-X′. In some embodiments, the cowl 106 further includes a radially outer surface 110 opposite to the radially inner surface 108.

In some embodiments, the cowl 106 further includes a blade 112 extending radially inwards from the radially inner surface 108 towards the central axis X-X′. In some embodiments, the blade 112 is configured to be at least partially received within the groove 104 of the casing 102. In some embodiments, the blade 112 mates with the groove 104 and fits into the groove 104 when the cowl 106 rotates about its hinges (not shown) with respect to the casing 102 and gets closed. Thus, the blade 112 may secure the cowl 106 to the casing 102. Alternatively, the blade 112 may extend from the casing 102 and the groove 104 may be disposed on the cowl 106.

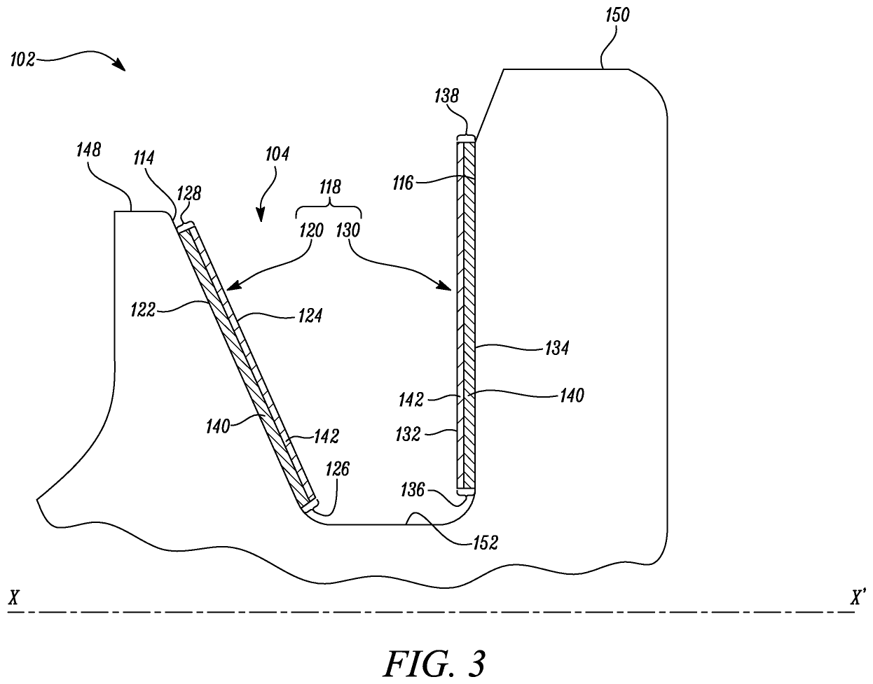

FIG. 3 is a schematic sectional view of a portion of the casing 102 including the groove 104 and a liner 118, according to an embodiment of the present disclosure. In some embodiments, the groove 104 includes a first groove surface 114 and a second groove surface 116 axially spaced apart from the first groove surface 114 relative to the central axis X-X′. In the illustrated embodiment of FIG. 3, the groove 104 is a V-shaped groove. However, it should be understood that the groove 104 may have any other cross-sectional shape, e.g., U-shape.

In some embodiments, the groove 104 further includes a first radially outer surface 148, a second radially outer surface 150, and a bottom groove surface 152. In some embodiments, the first radially outer surface 148 is disposed adjacent to the first groove surface 114 and the second radially outer surface 150 is disposed adjacent to the second groove surface 116. In some embodiments, the bottom groove surface 152 is disposed between the first groove surface 114 and the second groove surface 116. The bottom groove surface 152 is radially inward of each of the first groove surface 114 and the second groove surface 116.

The gas turbine engine 10 further includes the liner 118 at least partially received within the groove 104. The liner 118 includes at least one first liner portion 120. The at least one first liner portion 120 at least partially extends along the first groove surface 114 around the central axis X-X′. The liner 118 further includes at least one second liner portion 130 spaced apart from the at least one first liner portion 120. The at least one second liner portion 130 at least partially extends along the second groove surface 116 around the central axis X-X′. In some embodiments, the at least one first liner portion 120 is inclined to the at least one second liner portion 130.

The term “at least one first liner portion 120” is interchangeably used hereinafter as the “first liner portion 120”. The term “at least one second liner portion 130” is interchangeably used hereinafter as the “second liner portion 130”.

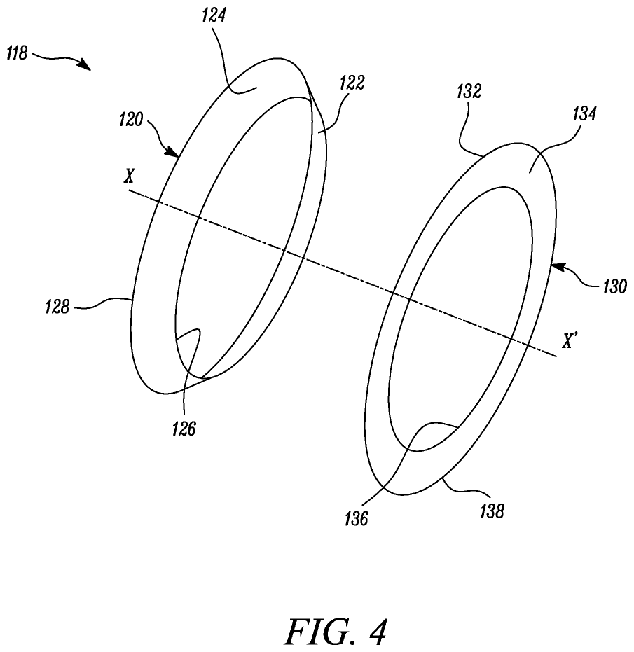

FIG. 4 is a schematic perspective view of the liner 118. In the illustrated embodiment of FIG. 4, the at least one first liner portion 120 has a circumferential extent of 360 degrees around the central axis X-X′. Further, the at least one second liner portion 130 has a circumferential extent of 360 degrees around the central axis X-X′. Each of the at least one first liner portion 120 and the at least one second liner portion 130 at least circumferentially and radially extends with respect to the central axis X-X′.

Referring now to FIGS. 3 and 4, the at least one first liner portion 120 includes a first upstream surface 122 and a first downstream surface 124 opposite to the first upstream surface 122. Specifically, the first upstream surface 122 of the at least one first liner portion 120 is configured to at least partially engage with the first groove surface 114 of the groove 104. Further, the first downstream surface 124 of the at least one first liner portion 120 at least partially engages the blade 112 (shown in FIG. 2).

In some embodiments, the at least one first liner portion 120 further includes a first inner circumferential edge 126 proximal to the central axis X-X′ and a first outer circumferential edge 128 opposing the first inner circumferential edge 126. In some cases, a length of the first outer circumferential edge 128 is greater than a length of the first inner circumferential edge 126.

Similarly, the second liner portion 130 includes a second upstream surface 132 and a second downstream surface 134 opposite to the second upstream surface 132. Specifically, the second downstream surface 134 of the second liner portion 130 is configured to at least partially engage with the second groove surface 116 of the groove 104 and the second upstream surface 132 faces the first downstream surface 124. Further, the second upstream surface 132 of the second liner portion 130 at least partially engages the blade 112 (shown in FIG. 2).

In some embodiments, the at least one second liner portion 130 further includes a second inner circumferential edge 136 proximal to the central axis X-X′ and a second outer circumferential edge 138 opposing the second inner circumferential edge 136. In some cases, a length of the second outer circumferential edge 138 is greater than a length of the second inner circumferential edge 136.

In some embodiments, at least one of the at least one first liner portion 120 and the at least one second liner portion 130 has a hollow frustoconical shape around the central axis X-X′. In the illustrated embodiments of FIGS. 3 and 4, the first liner portion 120 has the hollow frustoconical shape. Further, the second liner portion 130 has an annular shape. In some other embodiments, the first liner portion 120 and the second liner portion 130 may have any suitable cross-sectional shape, e.g., square, triangular, rectangular, oval, elliptical, polygonal, irregular, or the like based on application attributes.

As shown in FIG. 3, each of the at least one first liner portion 120 and the at least one second liner portion 130 includes a substrate 140 made of a metallic material and a wear resistant coating 142 disposed on at least a portion of the substrate 140. Specifically, the wear resistant coating 142 forms the first downstream surface 124 of the at least one first liner portion 120 and the second upstream surface 132 of the at least one second liner portion 130.

In some embodiments, the substrate 140 may have a thickness of about 0.5 millimetres (mm). In some embodiments, the metallic material may include titanium, steel, aluminium, a nickel-based alloy, a copper-based alloy, or combinations thereof. In some embodiments, the substrate 140 may be made from an easily formable metal alloy. In some embodiments, the metallic material may be corrosion resistant, especially resistant to galvanic corrosion. It should be understood that the substrate 140 may also be made from other suitable materials (e.g., polymer, composite, etc.) based on application requirements.

The wear resistant coating 142 is made of a polymeric material. In some embodiments, the polymeric material may be any suitable material that is durable, resistant to engine environment (i.e., exposure to corrosive fluids, high temperature, etc.), and compatible with the metallic material of the substrate 140 and a material of the blade 112 (shown in FIG. 2). In some embodiments, the polymeric material may include polyimide (in tape and solid polymer form), polyurethane, polytetrafluoroethylene (PTFE), polyether ether ketone (PEEK), ethylene chlorotrifluoroethylene (ECTFE), ethylene tetrafluoroethylene (ETFE), polyvinylidene fluoride (PVDF), or combinations thereof. It should be understood that the aforementioned list of materials is provided for exemplary purposes and other suitable materials are also within the scope of the present disclosure.

In some embodiments, the liner 118 may protect the first groove surface 114 and the second groove surface 116 from wear that is otherwise caused by contact stresses arising due to engagement as well as relative movement between the groove 104 and the blade 112 (shown in FIG. 2). Specifically, the wear resistant coating 142 of each of the first liner portion 120 and the second liner portion 130 may prevent direct contact between the blade 112 (shown in FIG. 2) and the groove 104, thereby protecting the first groove surface 114 and the second groove surface 116 from fretting. Thus, the liner 118 of the present disclosure may increase an operational life of the groove 104 and may mitigate the need to refurbish the groove 104 during a service life of the gas turbine engine 10 (shown in FIGS. 1 and 2). By eliminating wear, the groove 104 may be made from relatively low-cost softer materials (e.g., aluminium).

Additionally, the liner 118 of the present disclosure may provide a low-cost solution to prevent wear and tear of the first groove surface 114 and the second groove surface 116. Presence of the wear resistant coating 142 on the substrate 140 may allow low-cost materials to be chosen for the substrate 140 that are compatible with the material of the groove 104. Thus, the liner 118 of the present disclosure may eliminate the need to use relatively costlier materials, such as composites, hard and high strength steels.

Further, the liner 118 of the present disclosure may ease manufacturing since the liner 118 includes the first liner portion 120 separate from the second liner portion 130. This may also facilitate in replacement of the first liner portion 120 and the second liner portion 130 upon wear. Given the thinness of the liner 118, the first liner portion 120 and the second liner portion 130 may be cut-out as flat pieces (e.g., conical arcs) and then bent to shape for installing on the groove 104.

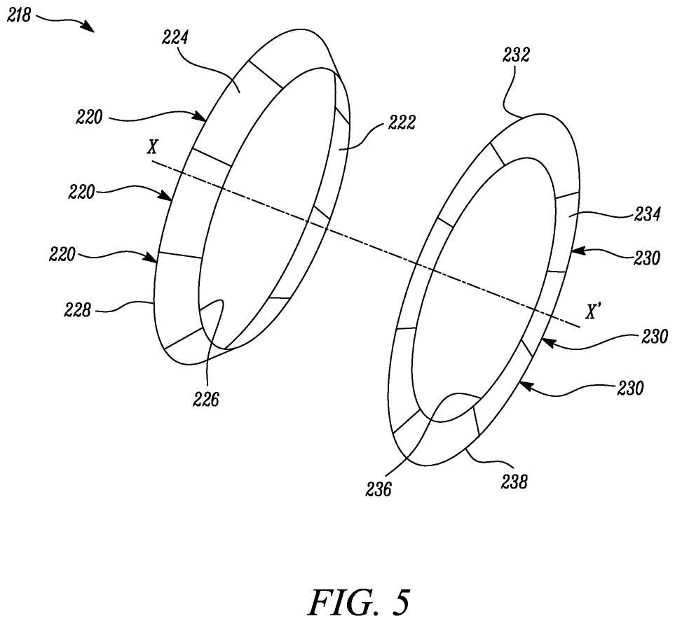

FIG. 5 is a schematic perspective view of a liner 218 for use with the gas turbine engine 10 (shown in FIG. 2), according to another embodiment of the present disclosure. In some embodiments, the liner 218 may be substantially similar to the liner 118 of FIGS. 3 and 4. The liner 218 includes at least one first liner portion 220 and at least one second liner portion 230 spaced apart from the at least one first liner portion 220. Some of the components of the liner 218 (e.g., the substrate 140 and the wear resistant coating 142 shown in FIG. 3) are not shown in FIG. 5 for the purpose of illustration.

In the illustrated embodiment of FIG. 5, the at least one first liner portion 220 includes a plurality of first liner portions 220 disposed circumferentially around the central axis X-X′. Specifically, the plurality of first liner portions 220 are disposed circumferentially adjacent to each other around the central axis X-X′. It should be noted that, in the illustrated embodiment of FIG. 5, eight first liner portions 220 are shown, however, the plurality of first liner portions 220 may include any number of first liner portions 220.

In some embodiments, each of the plurality of first liner portions 220 includes a first upstream surface 222 and a first downstream surface 224 opposite to the first upstream surface 222. The first upstream surface 222 is configured to at least partially engage with the first groove surface 114 (shown in FIG. 3). In some embodiments, each of the plurality of first liner portions 220 further includes a first inner circumferential edge 226 proximal to the central axis X-X′ and a first outer circumferential edge 228 opposing the first inner circumferential edge 226.

Similarly, the at least one second liner portion 230 includes a plurality of second liner portions 230 disposed circumferentially around the central axis X-X′. Specifically, the plurality of second liner portions 230 are disposed circumferentially adjacent to each other around the central axis X-X′. It should be noted that, in the illustrated embodiment of FIG. 5, eight second liner portions 230 are shown, however, the plurality of second liner portions 230 may include any number of second liner portions 230. It should be understood that the number of first liner portions 220 may or may not be equal to the number of second liner portions 230.

In some embodiments, each of the plurality of second liner portions 230 includes a second upstream surface 232 and a second downstream surface 234 opposite to the second upstream surface 232. The second downstream surface 234 is configured to at least partially engage with the second groove surface 116 (shown in FIG. 3). In some embodiments, each of the plurality of second liner portions 230 further includes a second inner circumferential edge 236 proximal to the central axis X-X′ and a second outer circumferential edge 238 opposing the second inner circumferential edge 236.

The plurality of first liner portions 220 and the plurality of second liner portions 230 may facilitate installation of the liner 218 on the groove 104 (shown in FIG. 3). Further, individual first liner portions 220 and second liner portions 230 may be conveniently replaced upon wear.

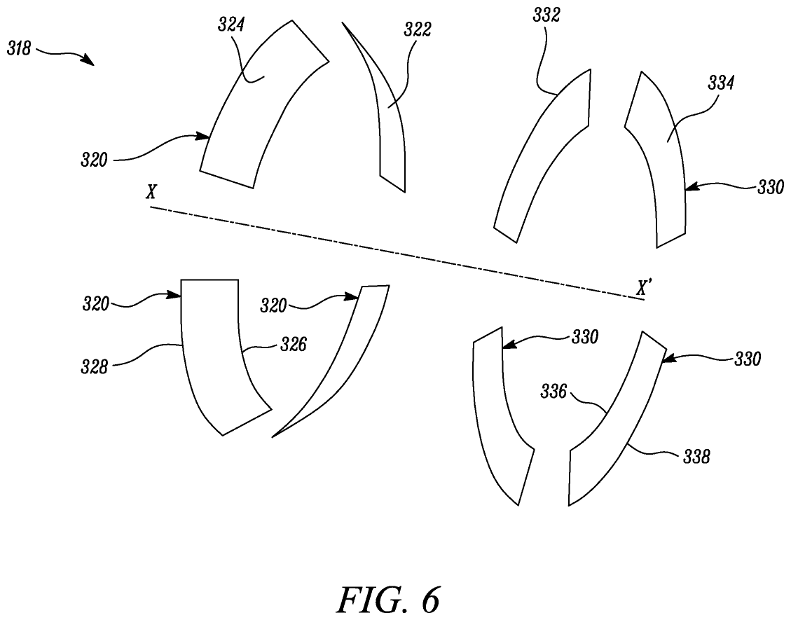

FIG. 6 is a schematic perspective view of a liner 318 for use with the gas turbine engine 10 (shown in FIG. 2), according to another embodiment of the present disclosure. In some embodiments, the liner 318 may be substantially similar to the liner 218 of FIG. 5. The liner 318 includes at least one first liner portion 320 and at least one second liner portion 330 spaced apart from the at least one first liner portion 320.

In the illustrated embodiment of FIG. 6, the at least one first liner portion 320 includes a plurality of first liner portions 320. In some embodiments, the plurality of first liner portions 320 are angularly spaced apart from each other with respect to the central axis X-X′. It should be noted that, in the illustrated embodiment of FIG. 6, four first liner portions 320 are shown, however, the plurality of first liner portions 320 may include any number of first liner portions 320.

In some embodiments, each first liner portion 320 from the plurality of first liner portions 320 forms a hollow frustoconical segment around the central axis X-X′. In some embodiments, each of the plurality of first liner portions 320 includes a first upstream surface 322 and a first downstream surface 324 opposite to the first upstream surface 322. The first upstream surface 322 is configured to at least partially engage with the first groove surface 114 (shown in FIG. 3). In some embodiments, each of the plurality of first liner portions 320 further includes a first inner circumferential edge 326 proximal to the central axis X-X′ and a first outer circumferential edge 328 opposing the first inner circumferential edge 326.

Similarly, the at least one second liner portion 330 includes a plurality of second liner portions 330 disposed circumferentially around the central axis X-X′. In some embodiments, the plurality of second liner portions 330 are angularly spaced apart from each other with respect to the central axis X-X′. It should be noted that, in the illustrated embodiment of FIG. 6, four second liner portions 330 are shown, however, the plurality of second liner portions 330 may include any number of second liner portions 330. It should be understood that the number of first liner portions 320 may or may not be equal to the number of second liner portions 330.

In some embodiments, each second liner portion 330 from the plurality of second liner portions 330 forms an annular segment around the central axis X-X′. In some embodiments, each of the plurality of second liner portions 330 includes a second upstream surface 332 and a second downstream surface 334 opposite to the second upstream surface 332. The second downstream surface 334 is configured to at least partially engage with the second groove surface 116 (shown in FIG. 3). In some embodiments, each of the plurality of second liner portions 330 further includes a second inner circumferential edge 336 proximal to the central axis X-X′ and a second outer circumferential edge 338 opposing the second inner circumferential edge 336.

The plurality of first liner portions 320 and the plurality of second liner portions 330 may facilitate installation of the liner 318 on the groove 104 (shown in FIG. 3). In some embodiments, the groove 104 or the blade 112 (shown in FIG. 2) may at least partially extend circumferentially around the central axis X-X′. Thus, the liner 318 may allow reduction in a material required to protect the groove 104 (shown in FIG. 2) since the plurality of first liner portions 320 and the plurality of second liner portions 330 may not extend 360 degrees around the central axis X-X′.

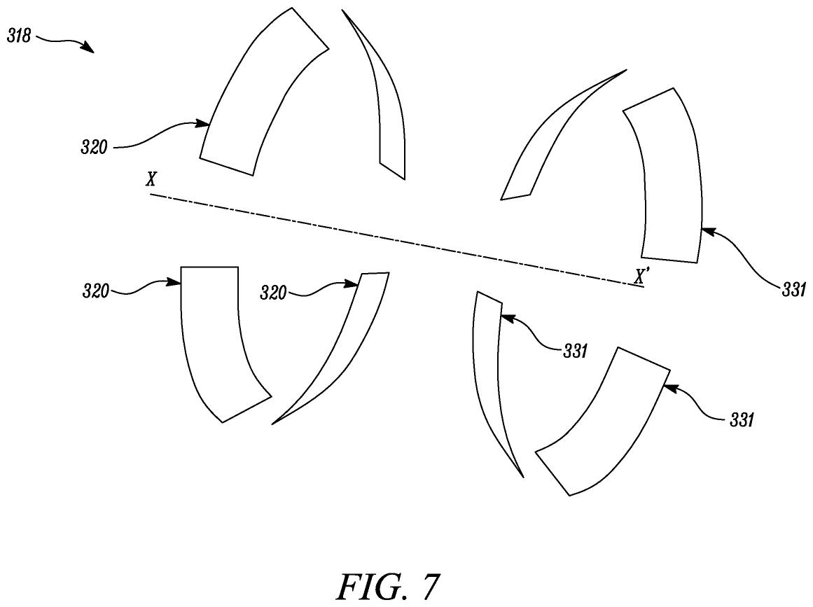

FIG. 7 is a schematic perspective view of the liner 318, according to another embodiment of the present disclosure. In the illustrated embodiment of FIG. 7, the liner 318 includes the at least one first liner portion 320 and at least one second liner portion 331. The at least one first liner portion 320 includes the plurality of first liner portions 320. The at least one second liner portion 331 includes a plurality of second liner portions 331.

In some embodiments, each second liner portion 331 from the plurality of second liner portions 331 forms a hollow frustoconical segment around the central axis X-X′. Thus, the plurality of second liner portions 331 may be similar to the plurality of first liner portions 320. Such an arrangement may be useful where a shape of the second groove surface 116 (shown in FIG. 3) is similar to a shape of the first groove surface 114 (shown in FIG. 3).

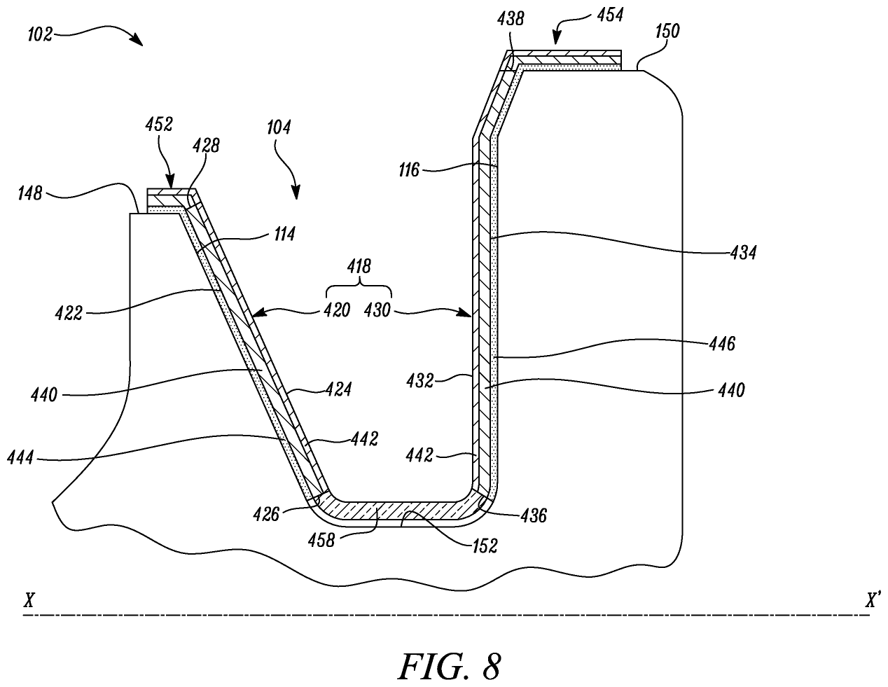

FIG. 8 is a schematic sectional view of the portion of the casing 102 including the groove 104 and a liner 418, according to an embodiment of the present disclosure. In the illustrated embodiment of FIG. 8, the liner 418 is at least partially received within the groove 104. In some embodiments, the liner 418 is substantially similar to the liner 118 of FIG. 3.

The liner 418 includes at least one first liner portion 420 and at least one second liner portion 430 spaced apart from the at least one first liner portion 420. Each of the at least one first liner portion 420 and the at least one second liner portion 430 includes a substrate 440 made of the metallic material and a wear resistant coating 442 disposed on at least a portion of the substrate 440.

The at least one first liner portion 420 includes a first upstream surface 422 and a first downstream surface 424 opposite to the first upstream surface 422. The first upstream surface 422 of the at least one first liner portion 420 is configured to at least partially engage with the first groove surface 114 of the groove 104. Further, the first downstream surface 424 of the at least one first liner portion 420 at least partially engages the blade 112 (shown in FIG. 2). In some embodiments, the liner 418 further includes a first radially outer lip 452 extending from the at least one first liner portion 420. Specifically, the first radially outer lip 452 extends from a first outer circumferential edge 428 of the first liner portion 420. In some embodiments, the first radially outer lip 452 is configured to engage with the first radially outer surface 148 of the groove 104.

The second liner portion 430 includes a second upstream surface 432 and a second downstream surface 434 opposite to the second upstream surface 432. The second downstream surface 434 of the second liner portion 430 is configured to at least partially engage with the second groove surface 116 of the groove 104 and the second upstream surface 432 faces the first downstream surface 424. Further, the at least one second upstream surface 432 of the second liner portion 430 at least partially engages the blade 112 (shown in FIG. 2). In some embodiments, the liner 418 further includes a second radially outer lip 454 extending from the at least one second liner portion 430. Specifically, the second radially outer lip 454 extends from a second outer circumferential edge 438 of the second liner portion 430. In some embodiments, the second radially outer lip 454 is configured to engage with the second radially outer surface 150 of the groove 104.

In some embodiments, the first radially outer lip 452 and the second radially outer lip 454 may allow self-fixturing of the liner 418 on the groove 104. Thus, the first radially outer lip 452 and the second radially outer lip 454 may facilitate installation of the liner 418 on the groove 104. Further, the first radially outer lip 452 and the second radially outer lip 454 may also prevent damage to the liner 418 when the blade 112 (shown in FIG. 2) engages with the groove 104 since the first radially outer lip 452 and the second radially outer lip 454 may prevent peeling of outer edges of the liner 418.

In some embodiments, the gas turbine engine 10 (shown in FIG. 2) further includes a first adhesive layer 444 disposed between the first upstream surface 422 and the first groove surface 114. The first adhesive layer 444 is configured to adhesively bond the at least one first liner portion 420 to the groove 104. In other words, the first adhesive layer 444 adhesively bonds the first upstream surface 422 of the at least one first liner portion 420 to the first groove surface 114 of the groove 104.

In some embodiments, the gas turbine engine 10 (shown in FIG. 2) further includes a second adhesive layer 446 disposed between the second downstream surface 434 and the second groove surface 116. The second adhesive layer 446 is configured to adhesively bond the at least one second liner portion 430 to the groove 104. In other words, the second adhesive layer 446 adhesively bonds the second downstream surface 434 of the second liner portion 430 to the second groove surface 116 of the groove 104.

In some embodiments, the first and second adhesive layers 444, 446 may include an epoxy adhesive in the form of liquid, paste, or film. Other adhesive materials may include, but are not limited to, silicone polyurea (SPU), acrylic, silicone, rubber-based adhesives, cyanoacrylate, polyurethane, or a combination thereof. It should be understood that the first liner portion 420 and the second liner portion 430 may also be attached to the respective first groove surface 114 and the second groove surface 116, respectively, through any other suitable mechanism based on application requirements. In some embodiments, the first and second groove surfaces 114, 116 may be prepared through surface treatment before attaching the first liner portion 420 and the second liner portion 430, respectively. Additional tooling may be used to ensure correct positioning of the liner 418 with respect to the groove 104 during assembly.

In some embodiments, the liner 418 further includes at least one bottom liner portion 458 coupling the at least one first liner portion 420 to the at least one second liner portion 430. Specifically, the at least one bottom liner portion 458 extends between a first inner circumferential edge 426 of the first liner portion 420 and a second inner circumferential edge 436 of the second liner portion 430. In some embodiments, the at least one bottom liner portion 458 is disposed adjacent to the bottom groove surface 152 of the groove 104. In some embodiments, the at least one bottom liner portion 458 may circumferentially extend with respect to the central axis X-X′. In some embodiments, the at least one bottom liner portion 458 may have a circumferential extent of 360 degrees around the central axis X-X′. In some embodiments, the at least one bottom liner portion 458 may engage with the bottom groove surface 152 of the groove 104.

In some embodiments, the at least one bottom liner portion 458 may facilitate installation of the liner 418 on the groove 104. For example, a single bottom liner portion 458 connecting the first liner portion 420 and the second liner portion 430 may be pushed inside the groove 104 with the single bottom liner portion 458 ensuring alignment between the first and second liner portions 420, 430. Further, the at least one bottom liner portion 458 that attaches the first and second liner portions 420, 430 may be more resistant to detachment from the groove 104 through mechanisms, such as peel forces.

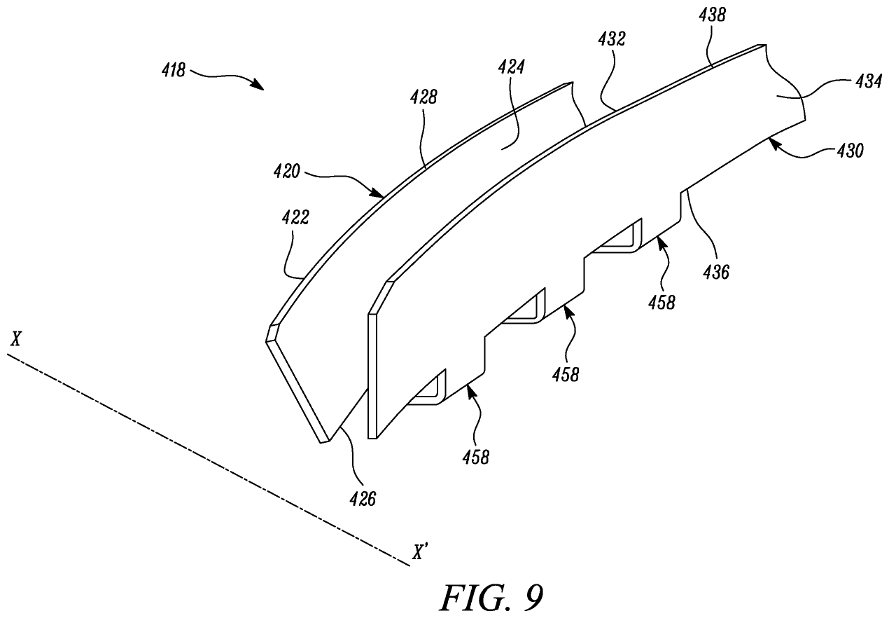

FIG. 9 is a schematic perspective view of the liner 418, according to another embodiment of the present disclosure. In the illustrated embodiment of FIG. 9, the first and second radially outer lips 452, 454 are not shown for the purpose of illustration. In some embodiments, the at least one first liner portion 420 further includes the first inner circumferential edge 426 proximal to the central axis X-X′ and the first outer circumferential edge 428 opposing the first inner circumferential edge 426. In some embodiments, a length of the first outer circumferential edge 428 is greater than a length of the first inner circumferential edge 426.

In some embodiments, the at least one second liner portion 430 further includes the second inner circumferential edge 436 proximal to the central axis X-X′ and the second outer circumferential edge 438 opposing the second inner circumferential edge 436. In some embodiments, a length of the second outer circumferential edge 438 is greater than a length of the second inner circumferential edge 436.

In some embodiments, the at least one bottom liner portion 458 includes a plurality of bottom liner portions 458 spaced apart from each other. Each bottom liner portion 458 from the plurality of bottom liner portions 458 couples the at least one first liner portion 420 to the at least one second liner portion 430. In some embodiments, each of the plurality of bottom liner portions 458 extends from the first inner circumferential edge 426 to the second inner circumferential edge 436. Each bottom liner portion 458 from the plurality of bottom liner portions 458 is disposed adjacent to the bottom groove surface 152 of the groove 104 (shown in FIG. 8).

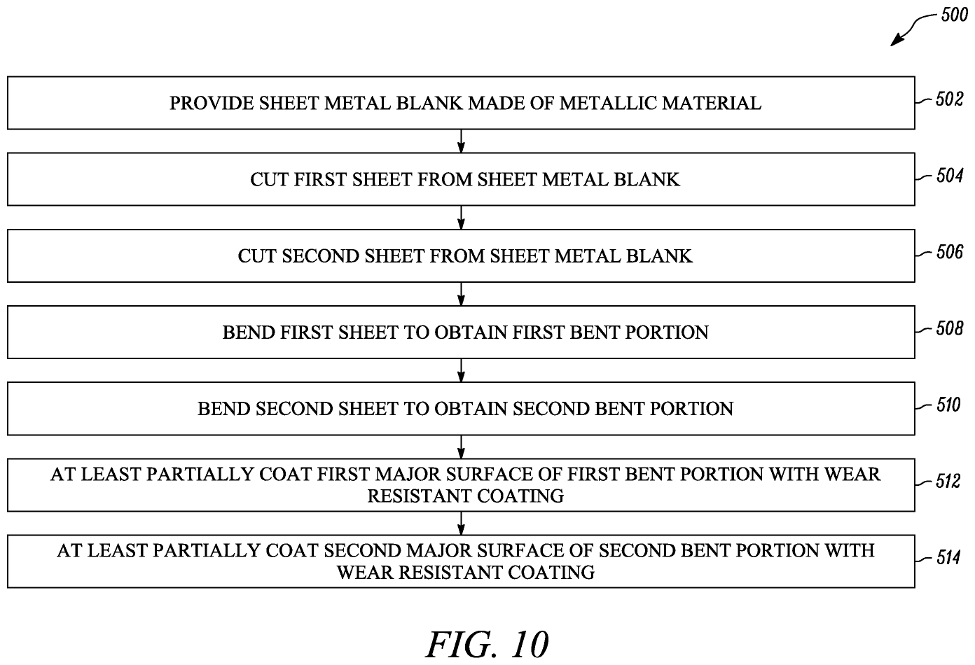

In some embodiments, the plurality of bottom liner portions 458 may be produced using a 2D bending method (e.g., pressing, rolling, etc.). In some embodiments, the plurality of bottom liner portions 458 may facilitate installation of the liner 418 on the groove 104 (shown in FIG. 8) while keeping a cost of producing the liner 418 low, e.g., through material savings. FIG. 10 is a flowchart illustrating a method 500 of manufacturing the liner 118. The method 500 will be described with reference to the liner 118, 218, 318 of FIGS. 3-7 and FIGS. 11A-11G.

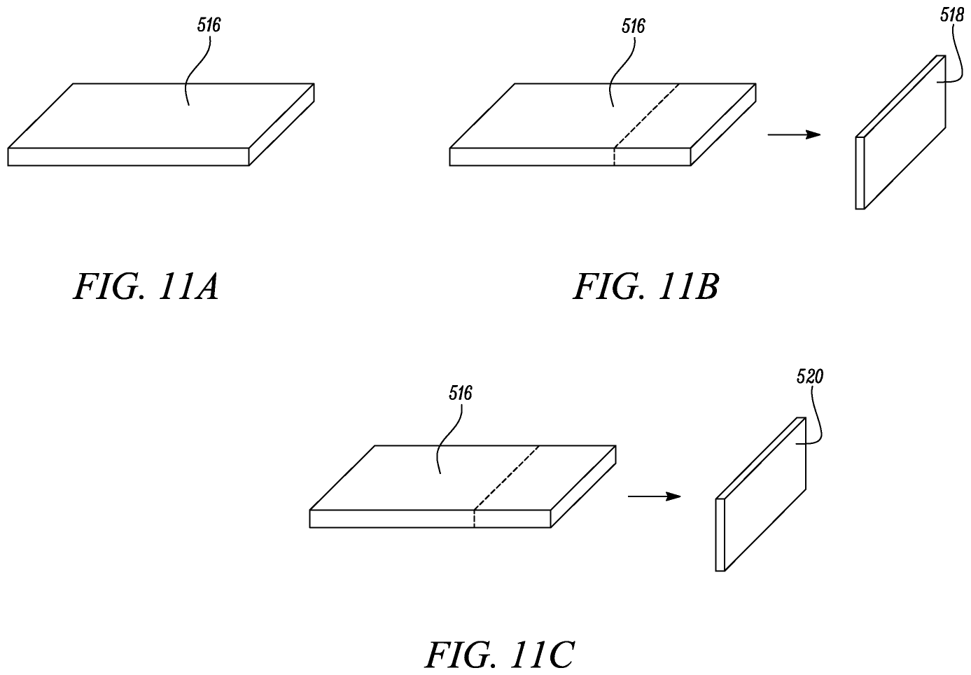

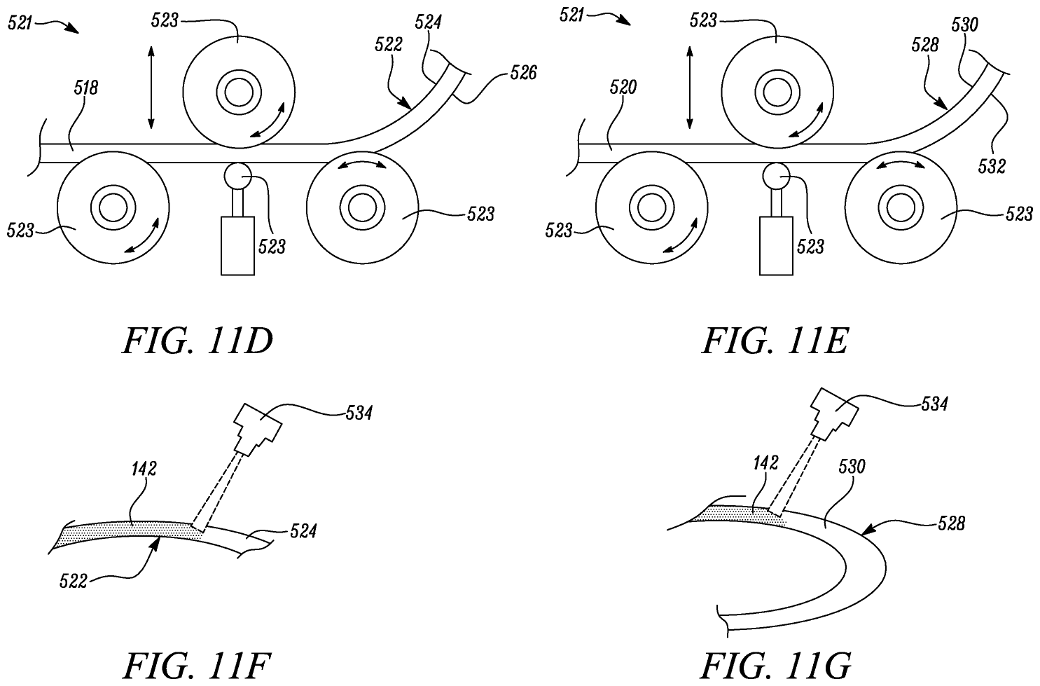

FIG. 11A is a schematic perspective view of a sheet metal blank 516. Referring to FIGS. 10 and 11A, at step 502, the method 500 includes providing the sheet metal blank 516 made of a metallic material. In some embodiments, the metallic material may include titanium, steel, aluminium, a nickel-based alloy, a copper-based alloy, or combinations thereof.

FIG. 11B is a schematic perspective view of the sheet metal blank 516 and a first sheet 518. Referring to FIGS. 10 and 11B, at step 504, the method 500 further includes cutting the first sheet 518 from the sheet metal blank 516. FIG. 11C is a schematic perspective view of the sheet metal blank 516 and a second sheet 520. Referring to FIGS. 10 and 11C, at step 506, the method 500 further includes cutting the second sheet 520 from the sheet metal blank 516. In some embodiments, the first sheet 518 (shown in FIG. 11B) and the second sheet 520 may be cut using any suitable method, e.g., shearing, stamping, laser cutting, etc. Further, in some embodiments, the first sheet 518 (shown in FIG. 11B) and the second sheet 520 may be cut simultaneously from the sheet metal blank 516.

FIG. 11D is a schematic side view of an apparatus 521 for bending the first sheet 518. Referring to FIGS. 10 and 11D, at step 508, the method 500 further includes bending the first sheet 518 to obtain a first bent portion 522. In some embodiments, the first bent portion 522 may be obtained by bending the first sheet 518 using one or more rollers 523 of the apparatus 521. The first bent portion 522 includes a first major surface 524 and an opposing second major surface 526.

FIG. 11E is a schematic side view of the apparatus 521 for bending the second sheet 520. Referring to FIGS. 10 and 11E, at step 510, the method 500 further includes bending the second sheet 520 to obtain a second bent portion 528. In some embodiments, the second bent portion 528 may be obtained by bending the second sheet 520 using the one or more rollers 523. The second bent portion 528 includes a first major surface 530 and an opposing second major surface 532. In some embodiments, the first sheet 518 (shown in FIG. 11D) and the second sheet 520 may be bent simultaneously.

It should be understood that the first sheet 518 (shown in FIG. 11D) and the second sheet 520 may be bent using any other suitable method, e.g., pressing. In some embodiments, pressing may be utilized for producing first and second liner portions (e.g., the liner 318 shown in FIGS. 6-8) that are in the form of small arcs. Pressing may also be utilized for producing different sizes of liners or liners having bottom liner portions forming connections between the first and second liner portions (e.g., the liner 418 shown in FIGS. 8 and 9). Moreover, pressing may also be utilized for producing liners with radially outer lips (e.g., the first and second radially outer lips 452, 454 shown in FIG. 8).

FIG. 11F is a schematic perspective view of a portion of the first bent portion 522. Referring now to FIGS. 10 and 11F, at step 512, the method 500 further includes at least partially coating the first major surface 524 of the first bent portion 522 with the wear resistant coating 142 in order to obtain the at least one first liner portion 120, 220, 320. The first major surface 524 of the first bent portion 522 may be coated using a coating head 534. The coating head 534 may spray the wear resistant coating 142 on the first major surface 524. It should be understood that any other suitable method may be utilized for producing the wear resistant coating 142 on the first major surface 524, e.g., hot coating, adhesive bonding, etc.

FIG. 11G is a schematic perspective view of a portion of the second bent portion 528. Referring now to FIGS. 10 and 11G, at step 514, the method 500 further includes at least partially coating the second major surface 532 of the second bent portion 528 with the wear resistant coating 142 in order to obtain the at least one second liner portion 130, 230, 330, 331. The second major surface 532 of the second bent portion 528 may be coated using the coating head 534. The coating head 534 may spray the wear resistant coating 142 on the second major surface 532. It should be understood that any other suitable method may be utilized for producing the wear resistant coating 142 on the second major surface 532, e.g., hot coating, adhesive bonding, etc. In some embodiments, the first bent portion 522 (shown in FIG. 11F) and the second bent portion 528 may be coated simultaneously.

Referring now to FIGS. 10-11G, the method 500 may allow bending of the first sheet 518 and the second sheet 520 to obtain the first bent portion 522 and the second bent portion 528, respectively, before at least partially coating the first major surface 524 of the first bent portion 522 and the second major surface 532 of the second bent portion 528 with the wear resistant coating 142. This may allow preservation of the wear resistant coating 142 before shaping operations. Such a method may be suitable for the first liner portion 120, 220, 320 and the second liner portion 130, 230, 330, 331 having specific geometries.

In some embodiments, the first liner portion 120, 220, 320 and the second liner portion 130, 230, 330, 331 may be produced simultaneously using the aforementioned steps. This may allow manufacturing of the liner 418 where the first liner portion 420 and the second liner portion 430 may be coupled together via the bottom liner portion 458.

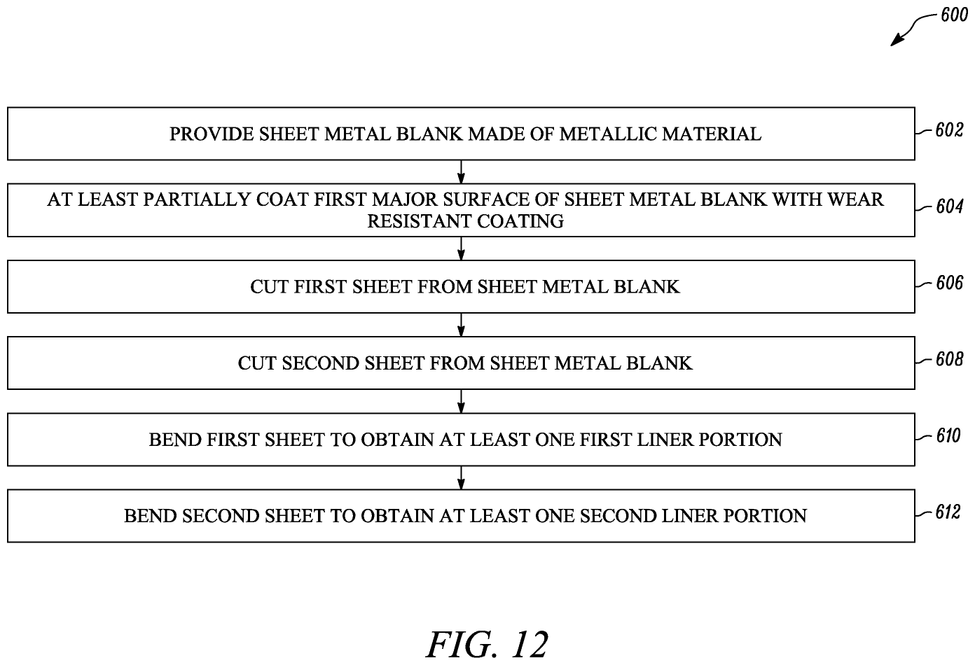

FIG. 12 is a flowchart illustrating a method 600 of manufacturing the liner 118. The method 600 will be described with reference to the liner 118, 218, 318 of FIGS. 3-7 and FIGS. 13A-13G.

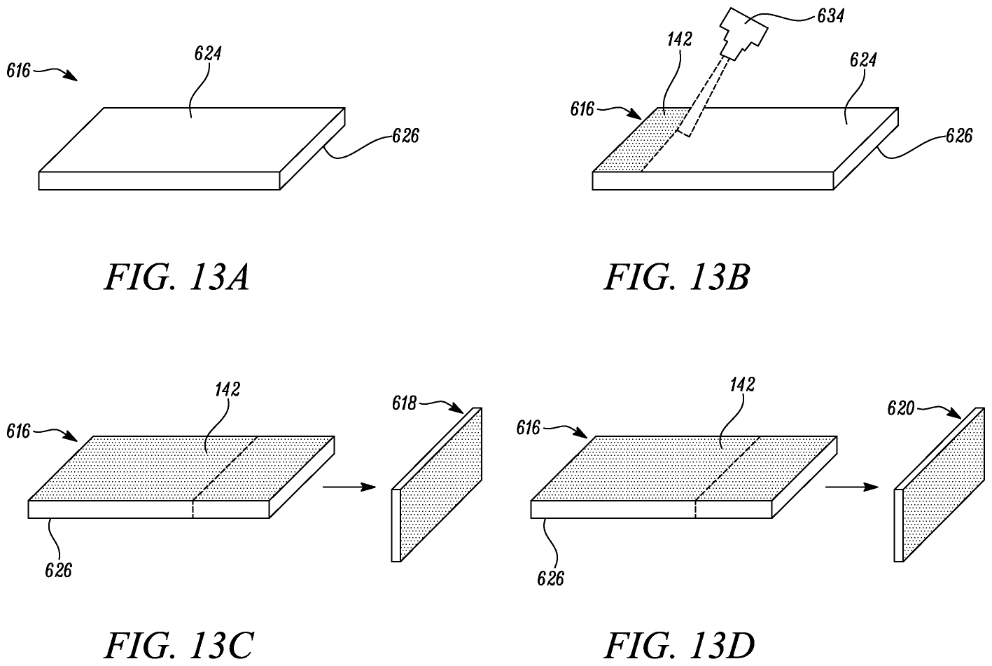

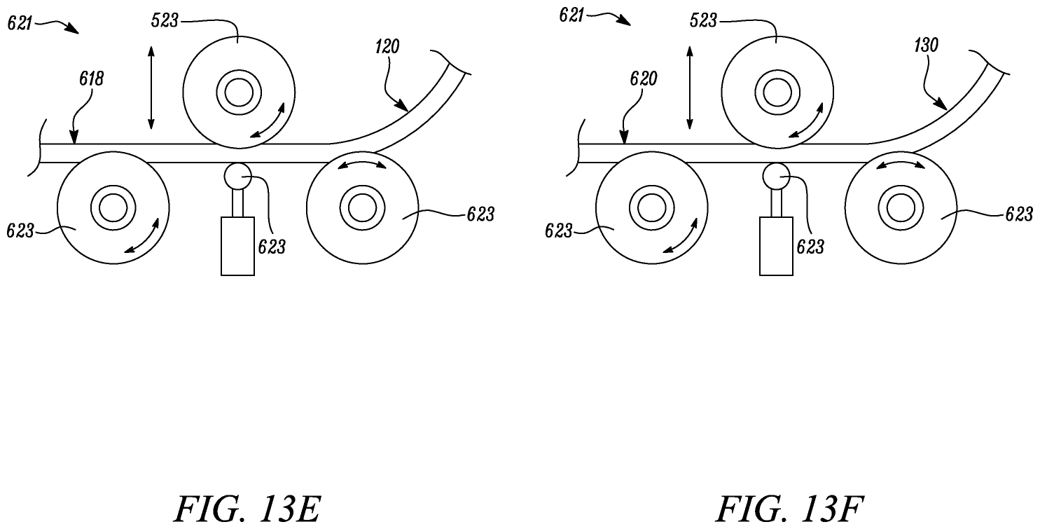

FIG. 13A is a schematic perspective view of a sheet metal blank 616. Referring now to FIGS. 12 and 13A, at step 602, the method 600 includes providing a sheet metal blank 616 made of the metallic material. In some embodiments, the sheet metal blank 616 is substantially similar to the sheet metal blank 516 (shown in FIG. 11A). The sheet metal blank 616 includes a first major surface 624 and an opposing second major surface 626.

FIG. 13B is a schematic perspective view of the sheet metal blank 616 where the first major surface 624 of the sheet metal blank 616 is at least partially coated. Referring now to FIGS. 12 and 13B, at step 604, the method 600 further includes at least partially coating the first major surface 624 of the sheet metal blank 616 with the wear resistant coating 142. The first major surface 624 may be coated using a coating head 634. The coating head 634 may spray the wear resistant coating 142 on the first major surface 624. It should be understood that any other suitable method may be utilized for producing the wear resistant coating 142 on the first major surface 624, e.g., hot coating, adhesive bonding, etc.

FIG. 13C is a schematic perspective view of the sheet metal blank 616 and a first sheet 618. Referring now to FIGS. 12 and 13C, at step 606, the method 600 further includes cutting the first sheet 618 from the sheet metal blank 616. FIG. 13D is a schematic perspective view of the sheet metal blank 616 and a second sheet 620. Referring now to FIGS. 12 and 13D, at step 608, the method 600 further includes cutting the second sheet 620 from the sheet metal blank 616. In some embodiments, the first sheet 618 (shown in FIG. 13C) and the second sheet 620 may be cut using any suitable method, e.g., shearing, stamping, laser cutting, etc. In some embodiments, the first sheet 618 (shown in FIG. 13C) and the second sheet 620 may be cut simultaneously.

FIG. 13E is a schematic side view of an apparatus 621 for bending the first sheet 618. Referring to FIGS. 12 and 13D, at step 610, the method 600 further includes bending the first sheet 618 to obtain the at least one first liner portion 120, 220, 320. In some embodiments, the first liner portion 120, 220, 320 may be obtained by bending the first sheet 618 using one or more rollers 623 of the apparatus 621.

FIG. 13F is a schematic side view of the apparatus 621 for bending the second sheet 620. Referring to FIGS. 12 and 13E, at step 612, the method 600 further includes bending the second sheet 620 to obtain the at least one second liner portion 130, 230, 330, 331. In some embodiments, the second liner portion 130, 230, 330, 331 may be obtained by bending the second sheet 620 using the one or more rollers 623. It should be understood that the first sheet 618 (shown in FIG. 13F) and the second sheet 620 may be bent using any other suitable method, e.g., pressing. Further, in some embodiments, the first sheet 618 (shown in FIG. 13E) and the second sheet 620 may be bent simultaneously.

Referring now to FIGS. 12-13F, coating the sheet metal blank 616 when flat and then shaping the first sheet 618 and the second sheet 620 to form the first liner portion 120, 220, 320 and the second liner portion 130, 230, 330, 331, respectively, may offer a low-cost production method. Further, in some embodiments, the first liner portion 120, 220, 320 and the second liner portion 130, 230, 330, 331 may be produced simultaneously using the aforementioned steps. This may allow manufacturing of the liner 418 where the first liner portion 420 and the second liner portion 430 may be coupled together via the bottom liner portion 458.

It should be understood that steps of the aforementioned methods are not necessarily presented in any particular order and that performance of some or all the steps in an alternative order(s) is possible and is contemplated. The steps have been presented in the demonstrated order for ease of description and illustration. Further, it should be understood that steps can be added, omitted and/or performed simultaneously without departing from the scope of the appended claims. Moreover, it should also be understood that the illustrated methods can be ended at any time.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A liner for use with a gas turbine engine having a groove, the liner comprising:
at least one first liner portion comprising a first upstream surface and a first downstream surface opposite to the first upstream surface, wherein the first upstream surface is configured to at least partially engage with a first groove surface of the groove; and
at least one second liner portion spaced apart from the at least one first liner portion the second liner portion comprising a second upstream surface and a second downstream surface opposite to the second upstream surface, wherein the second downstream surface is configured to at least partially engage with a second groove surface of the groove and the second upstream surface faces the first downstream surface;
wherein each of the at least one first liner portion and the at least one second liner portion at least circumferentially and radially extends with respect to a central axis (X-X′), wherein each of the at least one first liner portion and the at least one second liner portion comprises a substrate made of a metallic material and a wear resistant coating disposed on at least a portion of the substrate, wherein the wear resistant coating is made of a polymeric material, and wherein the wear resistant coating at least forms the first downstream surface of the at least one first liner portion and the second upstream surface of the at least one second liner portion.

2. The liner of claim 1, wherein the at least one first liner portion has a circumferential extent of 360 degrees around the central axis (X-X′), and wherein the at least one second liner portion has a circumferential extent of 360 degrees around the central axis (X-X′).

3. The liner of claim 2, wherein at least one of the at least one first liner portion and the at least one second liner portion has a hollow frustoconical shape around the central axis (X-X′).

4. The liner of claim 1, wherein the at least one first liner portion comprises a plurality of first liner portions disposed circumferentially around the central axis (X-X′), and the at least one second liner portion comprises a plurality of second liner portions disposed circumferentially around the central axis (X-X′).

5. The liner of claim 4, wherein the plurality of first liner portions is disposed circumferentially adjacent to each other around the central axis (X-X′), and wherein the plurality of second liner portions are disposed circumferentially adjacent to each other around the central axis (X-X′).

6. The liner of claim 4, wherein the plurality of first liner portions is angularly spaced apart from each other with respect to the central axis (X-X′), and wherein the plurality of second liner portions are angularly spaced apart from each other with respect to the central axis (X-X′).

7. The liner of claim 4, wherein each first liner portion from the plurality of first liner portions forms a hollow frustoconical segment around the central axis (X-X′).

8. The liner of claim 4, wherein each second liner portion from the plurality of second liner portions forms a hollow frustoconical segment around the central axis (X-X′).

9. The liner of claim 1, further comprising:
a first radially outer lip extending from the at least one first liner portion and configured to engage with a first radially outer surface of the groove; and
a second radially outer lip extending from the at least one second liner portion and configured to engage with a second radially outer surface of the groove.

10. The liner of claim 1, further comprising at least one bottom liner portion coupling the at least one first liner portion to the at least one second liner portion, wherein the at least one bottom liner portion is disposed adjacent to a bottom groove surface of the groove.

11. The liner of claim 10, wherein the at least one bottom liner portion comprises a plurality of bottom liner portions spaced apart from each other, and wherein each bottom liner portion from the plurality of bottom liner portions couples the at least one first liner portion to the at least one second liner portion, and wherein each bottom liner portion is disposed adjacent to the bottom groove surface of the groove.

12. The liner of claim 11, wherein:
the at least one first liner portion further comprises a first inner circumferential edge proximal to the central axis (X-X′) and a first outer circumferential edge opposing the first inner circumferential edge;
the at least one second liner portion further comprises a second inner circumferential edge proximal to the central axis (X-X′) and a second outer circumferential edge opposing the second inner circumferential edge; and
each of the plurality of bottom liner portions extends from the first inner circumferential edge to the second inner circumferential edge.

13. The liner of claim 1, wherein the at least one first liner portion is inclined to the at least one second liner portion.

14. The liner of claim 1, wherein the metallic material comprises titanium, steel, aluminium, a nickel-based alloy, a copper-based alloy, or combinations thereof.

15. The liner of claim 1, wherein the polymeric material comprises polyimide, polyurethane, polytetrafluoroethylene (PTFE), polyether ether ketone (PEEK), ethylene chlorotrifluoroethylene (ECTFE), ethylene tetrafluoroethylene (ETFE), polyvinylidene fluoride (PVDF), or combinations thereof.

16. A gas turbine engine comprising:
a central axis (X-X′);
a casing coaxial with and extending around the central axis (X-X′), the casing comprising a groove circumferentially extending around to the central axis (X-X′), the groove comprising a first groove surface and a second groove surface axially spaced apart from the first groove surface relative to the central axis (X-X′);
a cowl disposed axially spaced apart from the casing and circumferentially extending around the central axis (X-X′), wherein the cowl is rotatable relative to the casing and configured to detachably engage with the casing, wherein the cowl comprises a radially inner surface proximal to the central axis (X-X′), a radially outer surface opposite to the radially inner surface, and a blade extending radially inwards from the radially inner surface towards the central axis (X-X′), and wherein the blade is configured to be at least partially received within the groove of the casing; and
the liner of claim 1 at least partially received within the groove, wherein the at least one first liner portion at least partially extends along the first groove surface around the central axis (X-X′), wherein the at least one second liner portion at least partially extends along the second groove surface around the central axis (X-X′), wherein the first upstream surface of the at least one first liner portion at least partially engages with the first groove surface of the groove and the first downstream surface of the at least one first liner portion at least partially engages the blade, and wherein the second downstream surface of the at least one second liner portion at least partially engages with the second groove surface of the groove and the second upstream surface of the at least one second liner portion at least partially engages the blade.

17. The gas turbine engine of claim 16, further comprising: a first adhesive layer disposed between the first upstream surface and the first groove surface, wherein the first adhesive layer is configured to adhesively bond the at least one first liner portion to the groove; and
a second adhesive layer disposed between the second downstream surface and the second groove surface, wherein the second adhesive layer is configured to adhesively bond the at least one second liner portion to the groove.

18. A method of manufacturing the liner of claim 1, the method comprising:
providing a sheet metal blank made of the metallic material, the sheet metal blank comprising a first major surface and an opposing second major surface;
at least partially coating the first major surface of the sheet metal blank with the wear resistant coating;
cutting a first sheet from the sheet metal blank;
cutting a second sheet from the sheet metal blank;
bending the first sheet to obtain the at least one first liner portion; and
bending the second sheet to obtain the at least one second liner portion.
